(19) United States
(12) Patent Application Publication
(10) Pub. No.: US 2016/0055596 A1
(43) Pub. Date: Feb. 25, 2016

(54) REAL TIME CARBON EMISSIONS ASSIMILATION, REPORTING AND MANAGEMENT SYSTEM

(71) Applicants: Lavenya Dilip, Fremont, CA (US); Dilip V. Tinnelvelly, Fremont, CA (US); Abhishek Patankar, Mumbai, IN (US)

(72) Inventors: Lavenya Dilip, Fremont, CA (US); Dilip V. Tinnelvelly, Fremont, CA (US); Abhishek Patankar, Mumbai, IN (US)

(21) Appl. No.: 14/463,950

(22) Filed: Aug. 20, 2014

(51) Int. Cl. G06Q 40/00; G06Q 30/00

(52) U.S. Cl. CPC G06Q 40/12; G06Q 30/018

(57) ABSTRACT

A computer implemented method and system provides a carbon emissions management application (CEMA) for assimilating real time emission data (RTED) from sensors via a communication protocol, analyzing, and reporting of the RTED compliant with a governing body. The CEMA performs analytics using the RTED obtained from the detectors, that is, scope 1 emissions, user information, that is, scope 2 emissions resulting from purchased electricity, heat, etc., and supply chain data, that is, scope 3 emissions resulting from extraction and production of purchased materials from suppliers. The CEMA manages a carbon accounting system for reporting of the RTED by creating and managing financial statements, records such as journal entries associated with the RTED, etc., and setting up a compliance period for an entity during which the entity must disclose adequate allowances to meet carbon emissions by providing multiple accounting models and journal entry choices for calculation of the carbon emissions.

### CROSS REFERENCE TO RELATED APPLICATIONS

### Related Applications

The present application is a continuation-in-part application of U.S. provisional patent application, Ser. No. 61/867,621, filed Aug. 20, 2013, for REAL TIME CARBON EMISSIONS ASSIMILATION, REPORTING, AND MANAGEMENT SYSTEM, by Lavenya Dilip and Dilip V Tinnelvelly currently residing at 34297 Xanadu Ter,. Fremont Calif. 94555, included by reference herein and for which benefit of the priority date is hereby claimed.

The software developed from the time the provisional patent was filed (Aug. 20, 2013) is used to measure & analyze CO2 emission in any given industry. The complete sequence of the software implementation with screenshots is described below in detail.

The software prototype that has been developed to demonstrate the concept is used to measure and analyze CO2 emission in any given industry. This is divided into two parts outlined below.
(a) Analytics Section: This section is used to analyze as well as measure various Scope1, Scope2, Scope3 emissions.
(b) Accounting Section: This section helps accounting the Co2 emissions during an entire accounting period using various pre-defined accounting models.

FIG. 1 in the drawings file exemplarily illustrates a flowchart to develop the utility software to validate this patent (containing both the analytical and accounting portions including the sensor hardware that has been integrated to this software to provide real time emission results) comprising the steps for assimilating real time emission data 101, analyzing the real time emission data 101, and reporting the real time emission data 101. The computer implemented method disclosed herein provides a carbon emissions management application for assimilating the real time emission data 101 via a communication protocol where the inventors have used a Co2 Sensor purchased from the market (Co2meter.com) for implementing the concept for this Patent (OR commercial users can use on a larger scale for example, the Institute of Electrical and Electronics Engineers (IEEE) 802.15.4 Zigbee® wireless protocol of Zigbee Alliance Corporation, directly from detectors, for example, infrared sensors in terms of quantity and nature. The carbon emissions management application is implemented, for example, as system software, application software; embedded software programmed using a high level language which resides as firmware within embedded systems, etc. The carbon emissions management application is configured to operate, for example, as an enterprise based carbon accounting software for external financial reporting to the governing bodies using real time carbon emissions.

The carbon emissions management application assimilates real time emission data 101 from the detectors as disclosed in the detailed description of FIG. 2. The carbon emissions management application categorizes the real time emission data 101 from the detectors as scope 1 emission as defined by the greenhouse gas (GHG) protocol. The real time emission data 101 comprises, for example, data of greenhouse gases (GHG), for example, carbon dioxide (CO2), methane (CH4), nitrous oxide (N2O), hydro fluorocarbons (HFCs), per fluorocarbons (PFCs), sulfur hexafluoride (SF6), etc. The carbon emissions management application converts the GHG emission data into carbon and carbon dioxide equivalents for reporting purposes. The GHG protocol categorizes the direct and indirect emissions into three broad scopes, that is, scope 1 emission, scope 2 emissions, and scope 3 emissions. The scope 1 emissions comprise direct GHG emissions from the detectors. The scope 2 emissions comprise indirect GHG emissions resulting from consumption of purchased electricity, heat, steam, etc. The carbon score for scope 2 emissions are calculated, for example, based on the amount of purchased electricity. The scope 3 emissions comprise other indirect emissions resulting from, for example, extraction and production of purchased materials and fuels, transport-related activities in automobiles not owned or controlled by a reporting entity, electricity-related activities such as transmission and distribution losses not covered under scope 2 emissions, outsourced activities, waste disposal, etc.

The carbon emissions management application performs analytics 104 using the real time emission data 101 obtained from detectors via the communication protocol, user information 103, for example, scope 2 emissions such as emissions resulting from purchased electricity, heat, steam, etc., and supply chain data 102, for example, scope 3 emissions such as emissions resulting from the extraction and production of purchased materials and fuels from the suppliers. The carbon emissions management application displays the analyzed emission data on a dashboard with comparisons of historic emission data, types of emissions in the current year categorized, for example, based on types of scope 1 greenhouse gases, geographical location of the detectors, for example, a factory location, a manufacturing facility location, country if the entity's facilities are dispersed around the world, by products that the entity produces, and by suppliers that contribute to the emissions. The carbon emissions management application instantaneously aggregates the emission data provided by the suppliers with the entity's emission data. The carbon emissions management application adds inputs provided by the suppliers as a carbon footprint contributing to the entity's data as a whole. The carbon emissions management application categorizes the data assimilated from the suppliers as scope 3 emissions. The carbon emissions management application generates analytical reports 105 associated with the emission data and stores the analytical reports 105 in an entity's existing enterprise resource planning (ERP) system via an application programming interface (API), thereby allowing for a seamless integration into the entity's main stream of financial and accounting applications. The carbon emissions management application also manages a carbon accounting system 106 targeted at external financial reporting to federal authorities in compliance with the financial accounting standards board (FASB) and the generally accepted accounting principles (GAAP) for reporting to a governing body, for example, the securities and exchange commission (SEC) in the United States. The financial reporting standards comply with the International accounting standards board (IASB).

The carbon emissions management application uses the real time emission data 101 obtained from the detectors via the communication protocol and the user information 103 for financial reporting purposes. The carbon emissions management application enables a user to create and manage financial statements 107, for example, balance sheets, income statements, etc., associated with the entity. The carbon emissions management application begins 108 a compliance period for the entity during which the entity must disclose adequate allowances to meet the carbon emissions during the compliance period complaint with the governing body. The carbon emissions management application enables a user to create and manage financial statements 109, for example, account balance, balance sheets, income statements, balance sheet reports, etc., associated with the entity for the compliance period. The carbon emissions management application generates 110 records, for example, journal entries of the financial transactions automatically for allowances given by governing bodies, purchased allowances, emissions made by the entity, change in valuation of allowances on a yearly basis, while meeting required compliance obligations in the final year of the compliance period based on user driven guidance in terms of input parameters and the local governing bodies compliance requirements. The carbon emissions management application uploads the generated analytical reports 105, journal entries, general ledger and account balances, etc., associated with the emission data in the entity's existing enterprise resource planning (ERP) system via an application programming interface (API) allowing for a seamless integration into the company's main stream of financial and accounting applications.

The carbon emissions management application requests 111 users to choose between different generally accepted accounting models for carbon emissions reporting according to the required compliances local governing body. The carbon emissions management application enables the user to choose the standards of reporting for compliance. Once a particular path is chosen, the carbon emissions management application requests 111 users to input required data and generates journal entries according to the choices made by the users, thereby providing the users the authority to decide how they want the emissions to be reported while also giving them the choice to experiment between different modes of reporting so that they can make the best decision for their particular situation in terms of the company and the governing body. The carbon emissions management application receives an input from the user on the course of entries at each step in terms of valuation and an accounting model used for calculation of carbon emissions and recognition of allowances according to the financial accounting standards board (FASB), the International accounting standards board (IASB), the generally accepted accounting principles (GAAP), and other acceptable standards as dictated by the local governing bodies.

The carbon emissions management application enables the user to create and classify financial accounts using the carbon accounting system 106, for example, based on an asset, a liability, income, equity, expense, etc. The carbon emissions management application enables the user to choose the financial account names and respective categories, for example, asset, liability, income, expense, gain, loss, equity, etc., as recommended by the carbon emissions management application, or create the financial account names according to the user's preference. The carbon emissions management application generates a current view of balances in each financial account at a given point of time in the form of a dashboard. The carbon emissions management application continuously and simultaneously updates the emission liability of a financial account at each instance with the real time emission data 101 collected from the detectors, for example, the infrared sensors via the communication protocol due to emissions caused by an entity's operations in the compliance period. For example, the carbon emissions management application provides automatic instantaneous real time updates to an emission liability financial account for the current compliance year from real time scope 1 emissions data 101 collected from the detectors. The carbon emissions management application automatically uploads the updates to a general ledger to provide a real time account of the emissions by using standardized approaches and principles in order to increase accuracy and transparency in GHG accounting. The carbon emissions management application integrates with an existing general ledger maintained by the entity within standardized enterprise resource planning software application systems that the entity maintains through application programming interfaces (APIs). The carbon emissions management application creates new general ledger accounts and pre-programmed journal entries based on transactional data in compliance with GAAP and various proposed legislations around the world with respect to acceptable norms of carbon accounting for external reporting. The carbon emissions management application allows for one or more journal entries, for example, emission liability to be timed, to update the journal entries at regular time intervals throughout the compliance year according to the user's guidance.

FIG. 2 exemplarily illustrates specifications of a communication protocol for assimilating the real time emission data using a real time Co2 sensor which could also be replaced with the Zigbee protocol if used on a large scale. The carbon emissions management application assimilates real time emission data, that is, the carbon emissions from detectors. The detectors, for example, non dispersive infrared sensors are installed at locations such as factories, gas and power plants, etc., that are the origination points of greenhouse gas (GHG) emissions for entities. The non dispersive infrared sensors detect GHGs in the gaseous environment, measure the carbon emissions, and input the measured carbon emissions data to the carbon emissions management application. The detectors comprise internal radio frequency (RF) circuits and microcontrollers of 60KB to 1G flash memory to store, transmit, and receive emission data at an assigned frequency. For example, the assigned frequency pertaining to the United States for transmitting and receiving the emission data is 915 MHz and the assigned frequency pertaining to the Europe for transmitting and receiving the emission data is 868 MHz The carbon emissions management application wirelessly communicates with the detectors to extract real time emission data from the detectors, for example, via the sensor device. The carbon emissions management application is programmed to interact in the frequency range of the 2.4 GHz bandwidth, the 868 MHz bandwidth, and the 902-928 MHz bandwidth to conform to the United States, Canada, and European federal communications commission regulations.

FIG. 3 exemplarily illustrates the carbon emissions management application connected to multiple detectors 302 via a mesh network. The mesh network is a wireless network comprising a standard wireless communication protocol, for example, the IEEE 802.15.4 Zigbee® wireless protocol that is used to continuously transmit information between the detectors 302 and the carbon emissions management application residing, for example, in a central repository server 301 located either on the entity's premises or on a cloud computing network or grid as disclosed in the detailed description of FIG. 4. As used herein, the term “cloud computing network” refers to a network with a processing environment comprising configurable computing physical and logical resources, for example, networks, servers, storage, applications, services, etc., and data distributed over a network, for example, the internet. The cloud computing network provides on-demand network access to a shared pool of configurable computing physical and logical resources. The carbon emissions management application is programmed to collect the emission data wirelessly transmitted from the detectors 302 via the communication protocol.

FIG. 4 exemplarily illustrates the carbon emissions management application hosted on a cloud computing network 401. The carbon emissions management application assimilates real time emission data from the detectors, for example, via the IEEE 802.15.4 Zigbee® wireless protocol as disclosed in the detailed description of FIG. 2. The carbon emissions management application collects the emission data from the detectors via a centralized server located on the entity's premise or on the cloud computing network 401 and provides real time values of carbon emissions to report accurate numbers. The emission data flows from data sources to an operational data store and a data warehouse via an extraction, transformation and loading (ETL) process for external reporting purposes and internal management analytics. This process allows business users to visualize the emission data at an earlier stage in the development cycle and helps the business user to further refine requirements as the data is readily available on the cloud grid. Some examples of programming languages that can be used for programming the carbon emissions management application comprise C, C++, Java®, hypertext preprocessor (PHP), .NET, etc. The carbon emissions management application is programmed in an integrated design environment using the Eclipse framework executing on 32 bit/64 bit operating systems platforms. The carbon emissions management application provides end user applications, for example, data analysis and reporting, data mining, dashboards, pie charts, what-if analysis, external reporting, supply chain management, suppliers category, emission footprints results categorized by country, region, factory, product and supplier, etc., accruement of carbon emissions, regulations and compliances.

FIG. 5 exemplarily illustrates a table showing multiple accounting models and the journal entry choices provided by the carbon emissions management application for each of the accounting models. There are a number of different interpretations under the International financial reporting standards (MRS) currently being followed by entities in the world in terms of treatment of carbon accounting for carbon emissions. The accounting models supported by the carbon emissions management application are, for example, an intangible assets (IAS) 38 cost model, an IAS 38 revaluation model, a common model, a nil cost model, a fair value model for free allowances, a fair value model for purchased allowances, a forward contract model, a forward contract income model, a user driven model, etc. The accounting models support multiple journal entry choices provided by the carbon emissions management application as disclosed in the detailed description of FIGS. 6A-6F. For example, the IAS 38 cost model supports journal entry choices 1, 3, 4CL, 2, 6, and 5; the IAS 38 revaluation model supports journal entry choices 1, 8, 3, 4CL, 7, 2, 6, and 5, etc. The accounting models follow various applications of the International financial reporting interpretations committee (IFRIC).

The carbon emissions management application allows users to choose the path that they would like to follow for carbon accounting within acceptable and conventional parameters of financial reporting. The user starts a compliance period when allowances are given. The carbon emissions management application assigns a unique identifier and a name for the compliance period. The unique identifier and the name allow the user to return back to the compliance period each time the user logs into a financial account. The carbon emissions management application enables the user to create accounts for the compliance period, make journal entries, and choose an accounting model to dictate the accounting path to be taken. The carbon emissions management application then allows the user to close the compliance period once obligations are settled. The carbon emissions management application stores the compliance period for record keeping and revisions in a database which is accessible at a later time. The carbon emissions management application enables the user to start more than one compliance period sessions in parallel, thereby providing the user the opportunity to assess which model is right for the entity. The carbon emissions management application also allows for any journal entry in a compliance period to be deleted. The journal entries can also be imported from the user driven model into other pre-programmed accounting models allowing for increased flexibility and adaptation to changing accounting rules.

The IAS 38 cost model defines guidelines provided by the International accounting standards board (IASB) for accounting treatment of intangible assets which are non-monetary assets that lack physical substance and are identifiable. The IAS38 cost model treats carbon allowances as intangible assets. The entity records the initial allocation at market price and continues to carry the asset at this initial allocation till the end of the compliance period. The IAS38 cost model also recognizes a government grant that will be credited to income as emissions are made. If there is an initial price paid that is less than the market price, the difference between the market price and the price paid is recognized as a grant through a credit to the deferred income liability account. This deferred income is credited to income as emissions are made. The entity recognizes the total liability for emissions made at a fair value or at a weighted average cost of all allowances given or purchased according to the user's choice at the end of every compliance year. The carbon emissions management application adopts a total liability method for recording the real time liability by collecting the emission data from the detectors via the wireless communication protocol, for example, the IEEE 802.15.4 Zigbee® wireless protocol. The entity recognizes the acquisition of emission allowances for any excess emissions that are required. The entity settles the liability for emissions made over the entire compliance period by closing out the liability and allowance accounts, delivers the allowances, and also recognizes a loss or a profit in the process. The IAS 38 cost model is the benchmark against which the other accounting models are compared. The following accounting models will be elaborated based on similarities or variations with the IAS 38 cost model.

The IAS 38 revaluation model is similar to the IAS 38 cost model for treatment of allowances as intangible assets. However, after the initial recognition, the allowance shall be carried at a revalued amount at a fair value at the date of the revaluation every compliance year. The IAS 38 revaluation model is similar to the IAS 38 cost model in all other aspects. The common model is a variation of the IAS 38 cost model with the only difference being that the entity recognizes the liability for only those emissions in excess of allocated allowances. That is, the carbon emissions management application adopts an excess liability method for recording the real time liability by capturing the emission data from the detectors. The nil cost models recognizes allowances and deferred income at zero when allowances are provided for free. Emission liability is recognized every compliance year in the excess liability method. There is no deferred income or income recognition in the nil cost models.

In the fair value model for free allowances, after the recording of initial free allowances as an asset along with a credit to liability for the allocation, at fair value in the year of receipt of allowances, the entity revalues the allowance and liability at fair value every year and carries the allowance and the liability at fair value. The entity then recognizes liability for emissions every year using the excess liability method until the final compliance year when obligations are settled and allowances, emission liability, and liability for allowances are erased from the records. In the fair value model for purchased allowances, the allowances are not free and need to be purchased. The purchased allowances are recorded at a cost with a credit to cash feature. The entity re-measures purchased allowances at fair value every compliance year and carries the purchased allowances at fair value. The entity then recognizes liability for emissions every year using the complete liability method. In the final compliance year, the entity settles the liability for emissions made over the compliance period, erases the emission liability and allowances from the records, and delivers the allowances.

The forward contract model is for entities entering into forward contracts applying the “own used exemption” to forwards. As used herein, the term “forwards” refers to an agreement or a contract associated with an asset that binds one or more parties to oblige to the agreement. The forwards are purchased, for example, when electricity is sold for the whole compliance period. An accounting entry with respect to the forward purchase is not made at this time. The liability of emissions to date is measured every compliance year at a fair value. In the final compliance year, the entity recognizes the acquisition of emission allowances at a strike price and settles the liability for emissions made over the compliance period. In the forward contract-income model, an accounting entry is not made at the time of purchase of forwards. The liability of emissions to date is measured every compliance year at a fair value. In addition, income or expense is recognized for differences in forward price of allowances purchased and the current market price. The entries are made to asset account, for example, forwards and to the income or expense account depending on the direction of the market price change. In the final compliance year, the entity recognizes the acquisition of emission allowances at the strike price and settles the liability for emissions made over the compliance period. In the user driven model, the users can create their own journal entries. The journal entries can also be imported from the user driven model into other accounting models to create different combinations with other accounting models and increase flexibility and adaptation to changing accounting rules.

FIGS. 6A-6F exemplarily illustrate a journal entry table for multiple journal entry choices provided by the carbon emissions management application. The journal entry choices provided by the carbon emissions management application are, for example, record allocated allowances, record purchased allowances, income recognition-allowances, complete emission liability, excess emissions liability, record paid allocated allowances, settle obligation, allowance revaluation in equity, allowance asset and liability revaluation, allowance asset revaluation and income recognition, expense at forward price, expense at market price for forwards corresponding to journal entries 1, 2, 3, 4CL, 4EL, 5, 6, 7, 8, 9, 10, and 11 respectively in the journal entry table as exemplarily illustrated in FIGS. 6A-6F. In the journal entry table, for journal entries 4CL and 4EL, if the user chooses the weighted average option instead of a market price option, the market price used for calculations of emission liability and emission expense can be replaced by a weighted average of all allowances, thus far in the compliance period.

FIG. 7 illustrates the real time gas level as a graph with % of Co2 in real time plotted on Y-Axis and time on X-Axis (Every 5 minutes and the output is inputted into the software developed by the inventors for which the provisional utility patent is filed.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

### BACKGROUND OF THE INVENTION

As carbon emission programs gain impact across various countries including the United States, there is a need for entities to obtain a carbon emissions management tool that not only aids the entities to comply with regulatory bodies in terms of accountability but also to explore business and environmental consequences of greenhouse gas (GHG) emissions for which the entities are responsible. The financial accounting standards board (FASB) together with the International accounting standards board (IASB) is working on a joint project to address the need for accounting for carbon emissions and allowances for financial reporting. The environmental protection agency (EPA) is mandating that certain entities report the levels of greenhouse gases (GHG) emanated. For example, companies mainly in power, utilities, oil and natural gas production, and the transportation industry, etc., are required to participate in the EPA, regional greenhouse gas initiative (RGGI), and other carbon emission programs for reporting the levels of GHG involving a cap-and-trade model through the dispersion of allowances and tracking of actual emissions. Many companies may soon be required to disclose their impact on climate change and the regulation of GHG emissions, for example, in their annual securities and exchange commission (SEC) report on Form 10-K. The computer implemented method and software system (Analytics part+Accounting part) disclosed herein provides a carbon emissions management application for assimilating real time emission data, analyzing the real time emission data, and reporting the real time emission data. The carbon emissions management application assimilates real time emission data, for example, through the Co2meter infra red sensor (or the 802.15.4 Zigbee wireless protocol) for accumulating real time scope 1 carbon emissions data, for example, from infra-red sensors for data analytics, financial reporting to local governing bodies, and carbon accounting. The carbon emissions management application is configured to operate, for example, as an enterprise based carbon accounting software for external financial reporting to the governing bodies using real time carbon emissions. The carbon emissions management application assimilates the real time emission data via a communication protocol like the Co2 meter infrared sensor that has been used for developing this software with provisions to include or utilize a Zigbee® wireless protocol of Zigbee Alliance Corporation, directly from detectors, for example, infrared sensors in terms of quantity and nature.

Although some tools have been developed for reporting the levels of GHG from scope 2 emissions, for example, from utility services, purchased electricity, etc., they do not report automatic real time carbon emission updates of scope 1 GHG emissions, for example, GHG emissions resulting directly from sensors such as carbon gas emissions, sulfur dioxide (SO2) gas emissions, nitrogen dioxide (NO2) gas emissions, etc., along with an accounting system that performs external financial reporting to local governing bodies, for example, the SEC.

The above mentioned actual and anticipated developments with respect to GHG underline the need for a tracking, monitoring, and reporting system that provides real time information in order to enable business managers and other entities to meet government legislation and compliance requirements, operate in a more environmentally sustainable manner, and report accurately economic conditions and carbon performance of the entities using real time information. Moreover, there is a need for a computer implemented method and system that assimilates real time scope 1 emissions for businesses and that is not dedicated only to scope 2 emissions. Furthermore, there is a need for a computer implemented method and system that reports automatic real time carbon emission updates of scope 1 GHG emissions and provides an accounting system for the purpose of updated real time external financial reporting. Carbon emissions management application manages an accounting system for external financial reporting to local governing bodies. The carbon emissions management application maintains relevant accounts related to carbon accounting for federal reporting including assets, liabilities, expense, income and equity accounts. The carbon emissions management application generates records, for example, journal entries of the financial transactions automatically for allowances given by the governing bodies, purchased allowances, emissions made by an entity, changes in valuations of allowances on a yearly basis, while meeting required compliance obligations in the final year of a compliance period based on user driven guidance in terms of input parameters and the local governing bodies compliance requirements. The carbon emissions management application outputs analytical reports, journal entries, general ledger and account balances, etc., associated with the emission data. The carbon emissions management application uploads these outputs in the entity's existing enterprise resource planning (ERP) system via an application programming interface (API) allowing for a seamless integration into the entity's main stream of financial and accounting applications.

The carbon emissions management application receives an input from the user on the course of entries at each step in terms of valuation and an accounting model used for calculation of carbon emissions and recognition of allowances according to the financial accounting standards board (FASB), the International accounting standards board (IASB), the generally accepted accounting principles (GAAP), and other acceptable standards as dictated by the local governing bodies. The carbon emissions management application enables the user to create financial accounts, for example, an asset account, a liability account, an income account, an equity account, an expense account, etc. The carbon emissions management applications enables the user to choose the financial account names and respective categories, for example, asset, liability, income, expense, gain, loss, etc., as recommended by the carbon emissions management application or create the financial account names based on the user's preference. The carbon emissions management application generates a current view of balances in each financial account at a given point of time in the form of a dashboard. The carbon emissions management application updates an emission liability of the financial account at each instance with real time carbon emission data from the detectors via the communication protocol. The carbon emissions management application provides automatic instantaneous real time updates to the emission liability financial account for the current compliance year from real time scope 1 data collected from the detectors. The carbon emissions management application updates the journal entries, for example, emission liability at regular time intervals throughout the compliance year according to the user's guidance.

The carbon emissions management application uses information updated simultaneously from the detectors like the Co2 sensor (Purchased locally) used for validating this patent (For commercial usage on a very large scale, firms could use for example Zigbee® communication for which the software has a provision to seamlessly integrate the Zigbee hardware in lieu of the existing Co2 sensor used for validating this patent, to perform useful analytics geared to provide relevant and up to the minute updated emission data segregated into different levels, for example, in terms of scope of emissions, origin of emissions within an entity, type of greenhouse gases, products that the entity makes, and suppliers that contribute to the emissions. The carbon emissions management application performs external reporting using real time carbon emissions. The carbon emissions management application uses the sensors or Zigbee® protocol for obtaining real time greenhouse emissions data, that is, scope 1 emissions data as inputs for providing accurate carbon tracking and reporting for financial accounting purpose.

### SUMMARY OF THE INVENTION

The software prototype that has been developed to demonstrate the concept is used to measure and analyze CO2 emission in any given industry. This is divided into two parts outlined below.
(a) Analytics Section: This section is used to analyze as well as measure various Scope1, Scope2, Scope3 emissions.
(b) Accounting Section: This section helps accounting the Co2 emissions during an entire accounting period using various pre-defined accounting models.

The computer implemented method and system disclosed herein address the above stated needs for a tracking, monitoring, and reporting system that provides real time information in order to enable business managers and other entities to meet government legislation and compliance requirements, operate in a more environmentally sustainable manner, and report accurately economic conditions and carbon performance of the entities using the real time information via a communication protocol, through the Co2 sensor used in this patent (with provision to include in the software to use a 802.15.4 Zigbee wireless protocol of Zigbee Alliance Corporation). The computer implemented method and system disclosed herein also addresses the above stated need for assimilating scope 1 emissions along with scope 2 emissions. The carbon emissions management application performs real time analytics and scope 1 carbon emissions reporting by aggregating real time scope 1 emissions data from detectors, for example, infra-red sensors instantaneously, for example, using the 802.15.4 Zigbee wireless protocol. The carbon emissions management application receives inputs, for example, from the infrared sensors through the Co2 sensor used in this patent (with provision include in the software to use an 802.15.4 Zigbee wireless protocol). The computer implemented method and system disclosed herein also addresses the above stated need for reporting automatic real time carbon emission updates of scope 1 greenhouse gas (GHG) emissions, while providing an accounting system for the purpose of updated real time external financial reporting. The computer implemented method and system implements an interaction between detectors, for example, infrared sensors OR the 802.15.4 Zigbee wireless protocol, and a computer application, herein referred to as the “carbon emissions management application” that is programmed to receive inputs from the infrared sensors or through the medium of the Institute of Electrical and Electronics Engineers (IEEE) 802.15.4 Zigbee wireless protocol for financial tracking and reporting for commercial enterprises.

The computer implemented method and system disclosed herein provides a carbon emissions management application for assimilating real time emission data, analyzing the real time emission data, and reporting the real time emission data. The carbon emissions management application assimilates real time emission data, for example, through the 802.15.4 Zigbee protocol for accumulating real time scope 1 carbon emissions data, for example, from infra-red sensors for data analytics, financial reporting to local governing bodies, and carbon accounting. The carbon emissions management application is configured to operate, for example, as an enterprise based carbon accounting software for external financial reporting to the governing bodies using real time carbon emissions. The carbon emissions management application assimilates the real time emission data via a communication protocol, for example, a Zigbee® wireless protocol of Zigbee Alliance Corporation, directly from detectors, for example, infrared sensors in terms of quantity and nature.

The carbon emissions management application categorizes real time emission data assimilated from the direct detectors as scope 1 emissions according to a GHG protocol. The real time emission data comprises, for example, data of greenhouse gases (GHG), for example, carbon dioxide (CO2), methane (CH4), nitrous oxide (N2O), hydro fluorocarbons (HFCs), per fluorocarbons (PFCs), sulfur hexafluoride (SF6), etc. The carbon emissions management application performs real time analysis of the emission data and displays the analyzed emission data on a continuously updated and real time dashboard with comparisons of historic emission data, types of emissions in the current year categorized, for example, based on types of scope 1 greenhouse gases, geographical location of the detectors, for example, a factory location, a manufacturing facility location, country if the entity's facilities are spread around the world, and by product. The carbon emissions management application creates an in-depth detailed level of emission aggregation by taking into account the emission data provided by the entity's suppliers. The carbon emissions management application instantaneously aggregates the emission data provided by the suppliers with the entity's emission data. The carbon emissions management application adds the inputs provided by the suppliers as a carbon footprint contributing to the entity's data as a whole. The carbon emissions management application categorizes the data assimilated from the suppliers as Scope 3 emissions. The carbon emissions management application collects data from the user prior to the real time analysis of the emission data, and uses the data collected from the user to analyze scope 2 emissions. The carbon emissions management application renders reports in a dashboard format. The carbon emissions management application performs analytics using the real time emission data obtained from the detectors via the communication protocol, scope 2 emissions, and scope 3 emissions and generates analytical reports associated with the emission data.

The carbon emissions management application manages an accounting system for external financial reporting to local governing bodies. The carbon emissions management application maintains relevant accounts related to carbon accounting for federal reporting including assets, liabilities, expense, income and equity accounts. The carbon emissions management application generates records, for example, journal entries of the financial transactions automatically for allowances given by the governing bodies, purchased allowances, emissions made by an entity, changes in valuations of allowances on a yearly basis, while meeting required compliance obligations in the final year of a compliance period based on user driven guidance in terms of input parameters and the local governing bodies compliance requirements. The carbon emissions management application outputs analytical reports, journal entries, general ledger and account balances, etc., associated with the emission data. The carbon emissions management application uploads these outputs in the entity's existing enterprise resource planning (ERP) system via an application programming interface (API) allowing for a seamless integration into the entity's main stream of financial and accounting applications.

The carbon emissions management application receives an input from the user on the course of entries at each step in terms of valuation and an accounting model used for calculation of carbon emissions and recognition of allowances according to the financial accounting standards board (FASB), the International accounting standards board (IASB), the generally accepted accounting principles (GAAP), and other acceptable standards as dictated by the local governing bodies. The carbon emissions management application enables the user to create financial accounts, for example, an asset account, a liability account, an income account, an equity account, an expense account, etc. The carbon emissions management applications enables the user to choose the financial account names and respective categories, for example, asset, liability, income, expense, gain, loss, etc., as recommended by the carbon emissions management application or create the financial account names based on the user's preference. The carbon emissions management application generates a current view of balances in each financial account at a given point of time in the form of a dashboard. The carbon emissions management application updates an emission liability of the financial account at each instance with real time carbon emission data from the detectors via the communication protocol. The carbon emissions management application provides automatic instantaneous real time updates to the emission liability financial account for the current compliance year from real time scope 1 data collected from the detectors. The carbon emissions management application updates the journal entries, for example, emission liability at regular time intervals throughout the compliance year according to the user's guidance.

The carbon emissions management application uses information updated simultaneously from the sensor to perform useful analytics geared to provide relevant and up to the minute updated emission data segregated into different levels, for example, in terms of scope of emissions, origin of emissions within an entity, type of greenhouse gases, products that the entity makes, and suppliers that contribute to the emissions. The carbon emissions management application performs external reporting using real time carbon emissions. The carbon emissions management application uses the sensor (With provision to use Zigbee) obtaining real time greenhouse emissions data, that is, scope 1 emissions data as inputs for providing accurate carbon tracking and reporting for financial accounting purposes.

### BRIEF DESCRIPTION OF THE DRAWINGS

A complete understanding of the present invention may be obtained by reference to the accompanying drawings, when considered in conjunction with the subsequent, detailed description, in which:

FIG. 1 exemplarily illustrates a flowchart comprising the steps for assimilating real time emission data, analyzing the real time emission data, and reporting the real time emission data;

FIG. 2 exemplarily illustrates specifications of a communication protocol for assimilating the real time emission data;

FIG. 3 exemplarily illustrates a carbon emissions management application connected to multiple detectors via a mesh network;

FIG. 4 exemplarily illustrates the carbon emissions management application hosted on a cloud computing network;

FIG. 5 exemplarily illustrates a table showing multiple accounting models and journal entry choices provided by the carbon emissions management application for each of the accounting models;

FIGS. 6a-6f exemplarily illustrate a journal entry table for multiple journal entry choices provided by the carbon emissions management application;

For purposes of clarity and brevity, like elements and components will bear the same designations and numbering throughout the Figures.

### DETAILED DESCRIPTION OF THE INVENTION

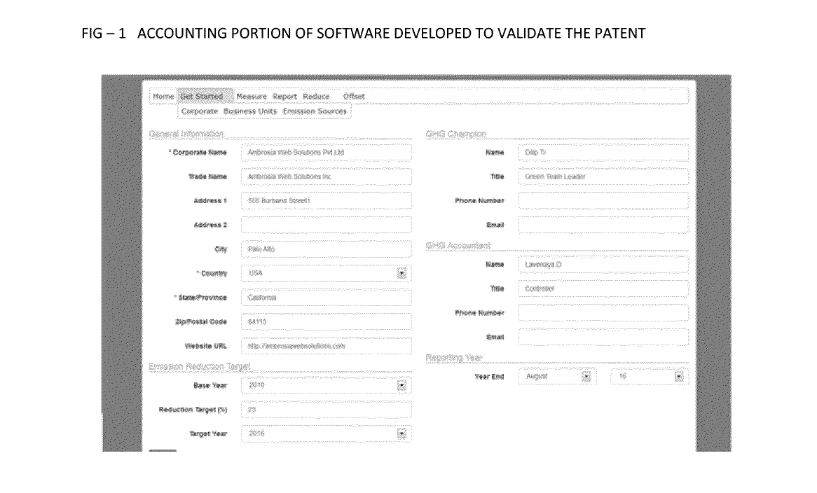

FIG. 1 exemplarily illustrates a flowchart to develop the utility software to validate this patent (containing both the analytical and accounting portions including the sensor hardware that has been integrated to this software to provide real time emission results) comprising the steps for assimilating real time emission data 101, analyzing the real time emission data 101, and reporting the real time emission data 101. The computer implemented method disclosed herein provides a carbon emissions management application for assimilating the real time emission data 101 via a communication protocol where the inventors have used a Co2 Sensor purchased from the market (Co2meter.com) for implementing the concept for this Patent (OR commercial users can use on a larger scale for example, the Institute of Electrical and Electronics Engineers (IEEE) 802.15.4 Zigbee® wireless protocol of Zigbee Alliance Corporation, directly from detectors, for example, infrared sensors in terms of quantity and nature. The carbon emissions management application is implemented, for example, as system software, application software; embedded software programmed using a high level language which resides as firmware within embedded systems, etc. The carbon emissions management application is configured to operate, for example, as an enterprise based carbon accounting software for external financial reporting to the governing bodies using real time carbon emissions.

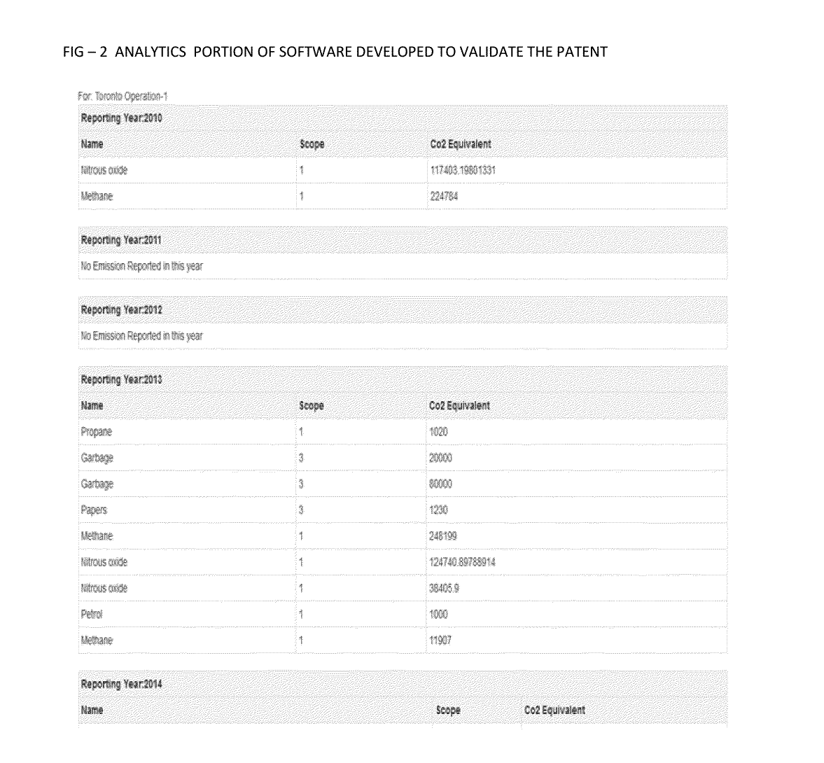

The carbon emissions management application assimilates real time emission data 101 from the detectors as disclosed in the detailed description of FIG. 2. The carbon emissions management application categorizes the real time emission data 101 from the detectors as scope 1 emission as defined by the greenhouse gas (GHG) protocol. The real time emission data 101 comprises, for example, data of greenhouse gases (GHG), for example, carbon dioxide (CO2), methane (CH4), nitrous oxide (N2O), hydro fluorocarbons (HFCs), per fluorocarbons (PFCs), sulfur hexafluoride (SF6), etc. The carbon emissions management application converts the GHG emission data into carbon and carbon dioxide equivalents for reporting purposes. The GHG protocol categorizes the direct and indirect emissions into three broad scopes, that is, scope 1 emission, scope 2 emissions, and scope 3 emissions. The scope 1 emissions comprise direct GHG emissions from the detectors. The scope 2 emissions comprise indirect GHG emissions resulting from consumption of purchased electricity, heat, steam, etc. The carbon score for scope 2 emissions are calculated, for example, based on the amount of purchased electricity. The scope 3 emissions comprise other indirect emissions resulting from, for example, extraction and production of purchased materials and fuels, transport-related activities in automobiles not owned or controlled by a reporting entity, electricity-related activities such as transmission and distribution losses not covered under scope 2 emissions, outsourced activities, waste disposal, etc.

The carbon emissions management application performs analytics 104 using the real time emission data 101 obtained from detectors via the communication protocol, user information 103, for example, scope 2 emissions such as emissions resulting from purchased electricity, heat, steam, etc., and supply chain data 102, for example, scope 3 emissions such as emissions resulting from the extraction and production of purchased materials and fuels from the suppliers. The carbon emissions management application displays the analyzed emission data on a dashboard with comparisons of historic emission data, types of emissions in the current year categorized, for example, based on types of scope 1 greenhouse gases, geographical location of the detectors, for example, a factory location, a manufacturing facility location, country if the entity's facilities are dispersed around the world, by products that the entity produces, and by suppliers that contribute to the emissions. The carbon emissions management application instantaneously aggregates the emission data provided by the suppliers with the entity's emission data. The carbon emissions management application adds inputs provided by the suppliers as a carbon footprint contributing to the entity's data as a whole. The carbon emissions management application categorizes the data assimilated from the suppliers as scope 3 emissions. The carbon emissions management application generates analytical reports 105 associated with the emission data and stores the analytical reports 105 in an entity's existing enterprise resource planning (ERP) system via an application programming interface (API), thereby allowing for a seamless integration into the entity's main stream of financial and accounting applications. The carbon emissions management application also manages a carbon accounting system 106 targeted at external financial reporting to federal authorities in compliance with the financial accounting standards board (FASB) and the generally accepted accounting principles (GAAP) for reporting to a governing body, for example, the securities and exchange commission (SEC) in the United States. The financial reporting standards comply with the International accounting standards board (IASB).

The carbon emissions management application uses the real time emission data 101 obtained from the detectors via the communication protocol and the user information 103 for financial reporting purposes. The carbon emissions management application enables a user to create and manage financial statements 107, for example, balance sheets, income statements, etc., associated with the entity. The carbon emissions management application begins 108 a compliance period for the entity during which the entity must disclose adequate allowances to meet the carbon emissions during the compliance period complaint with the governing body. The carbon emissions management application enables a user to create and manage financial statements 109, for example, account balance, balance sheets, income statements, balance sheet reports, etc., associated with the entity for the compliance period. The carbon emissions management application generates 110 records, for example, journal entries of the financial transactions automatically for allowances given by governing bodies, purchased allowances, emissions made by the entity, change in valuation of allowances on a yearly basis, while meeting required compliance obligations in the final year of the compliance period based on user driven guidance in terms of input parameters and the local governing bodies compliance requirements. The carbon emissions management application uploads the generated analytical reports 105, journal entries, general ledger and account balances, etc., associated with the emission data in the entity's existing enterprise resource planning (ERP) system via an application programming interface (API) allowing for a seamless integration into the company's main stream of financial and accounting applications.

The carbon emissions management application requests 111 users to choose between different generally accepted accounting models for carbon emissions reporting according to the required compliances local governing body. The carbon emissions management application enables the user to choose the standards of reporting for compliance. Once a particular path is chosen, the carbon emissions management application requests 111 users to input required data and generates journal entries according to the choices made by the users, thereby providing the users the authority to decide how they want the emissions to be reported while also giving them the choice to experiment between different modes of reporting so that they can make the best decision for their particular situation in terms of the company and the governing body. The carbon emissions management application receives an input from the user on the course of entries at each step in terms of valuation and an accounting model used for calculation of carbon emissions and recognition of allowances according to the financial accounting standards board (FASB), the International accounting standards board (IASB), the generally accepted accounting principles (GAAP), and other acceptable standards as dictated by the local governing bodies.

The carbon emissions management application enables the user to create and classify financial accounts using the carbon accounting system 106, for example, based on an asset, a liability, income, equity, expense, etc. The carbon emissions management application enables the user to choose the financial account names and respective categories, for example, asset, liability, income, expense, gain, loss, equity, etc., as recommended by the carbon emissions management application, or create the financial account names according to the user's preference. The carbon emissions management application generates a current view of balances in each financial account at a given point of time in the form of a dashboard. The carbon emissions management application continuously and simultaneously updates the emission liability of a financial account at each instance with the real time emission data 101 collected from the detectors, for example, the infrared sensors via the communication protocol due to emissions caused by an entity's operations in the compliance period. For example, the carbon emissions management application provides automatic instantaneous real time updates to an emission liability financial account for the current compliance year from real time scope 1 emissions data 101 collected from the detectors. The carbon emissions management application automatically uploads the updates to a general ledger to provide a real time account of the emissions by using standardized approaches and principles in order to increase accuracy and transparency in GHG accounting. The carbon emissions management application integrates with an existing general ledger maintained by the entity within standardized enterprise resource planning software application systems that the entity maintains through application programming interfaces (APIs). The carbon emissions management application creates new general ledger accounts and pre-programmed journal entries based on transactional data in compliance with GAAP and various proposed legislations around the world with respect to acceptable norms of carbon accounting for external reporting. The carbon emissions management application allows for one or more journal entries, for example, emission liability to be timed, to update the journal entries at regular time intervals throughout the compliance year according to the user's guidance.

FIG. 2 exemplarily illustrates specifications of a communication protocol for assimilating the real time emission data. The communication protocol is, for example, the IEEE 802.15.4 Zigbee® wireless protocol. The carbon emissions management application assimilates real time emission data, that is, the carbon emissions from detectors. The detectors, for example, non dispersive infrared sensors are installed at locations such as factories, gas and power plants, etc., that are the origination points of greenhouse gas (GHG) emissions for entities. The non dispersive infrared sensors detect GHGs in the gaseous environment, measure the carbon emissions, and input the measured carbon emissions data to the carbon emissions management application. The detectors comprise internal radio frequency (RF) circuits and microcontrollers of 60KB to 1G flash memory to store, transmit, and receive emission data at an assigned frequency. For example, the assigned frequency pertaining to the United States for transmitting and receiving the emission data is 915 MHz and the assigned frequency pertaining to the Europe for transmitting and receiving the emission data is 868 MHz The carbon emissions management application wirelessly communicates with the detectors to extract real time emission data from the detectors, for example, via the IEEE 802.15.4 ZigBee® wireless protocol. The carbon emissions management application is programmed to interact in the frequency range of the 2.4 GHz bandwidth, the 868 MHz bandwidth, and the 902-928 MHz bandwidth to conform to the United States, Canada, and European federal communications commission regulations.

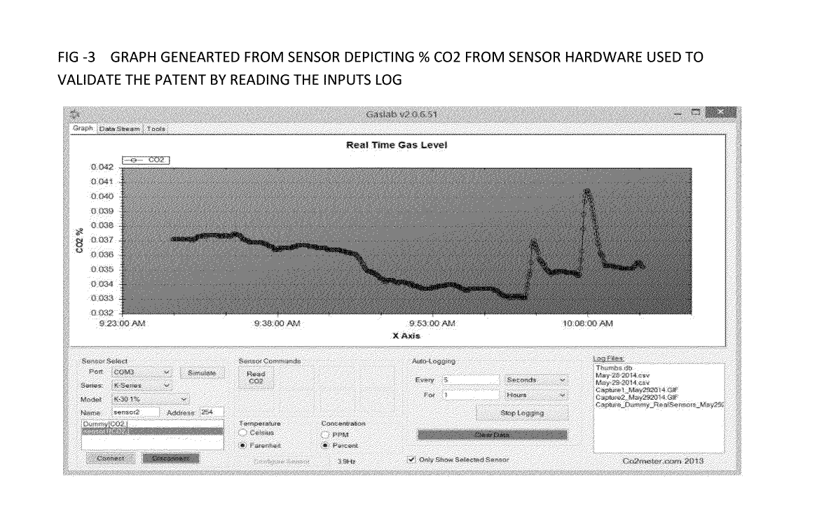

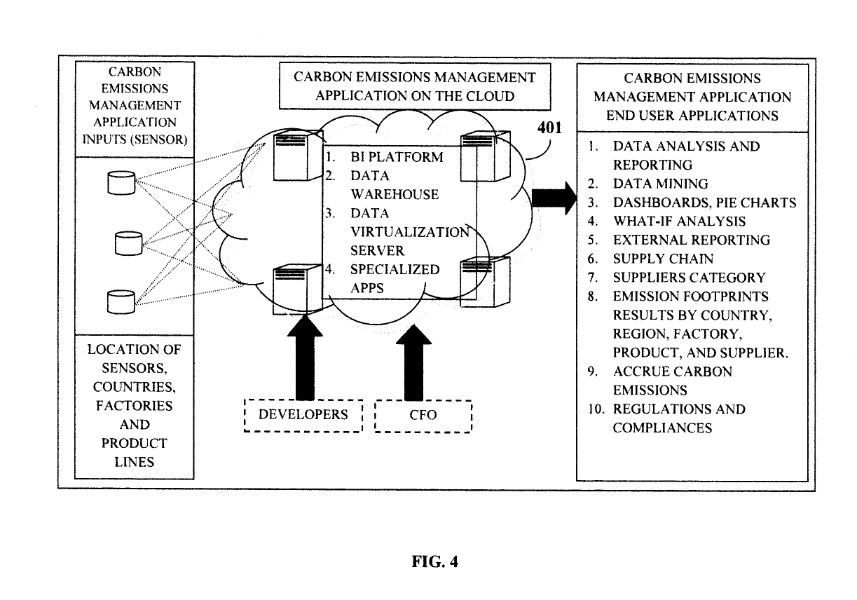

FIG. 3 exemplarily illustrates the carbon emissions management application connected to multiple detectors 302 via a mesh network. The mesh network is a wireless network comprising a standard wireless communication protocol, for example, the IEEE 802.15.4 Zigbee® wireless protocol that is used to continuously transmit information between the detectors 302 and the carbon emissions management application residing, for example, in a central repository server 301 located either on the entity's premises or on a cloud computing network or grid as disclosed in the detailed description of FIG. 4. As used herein, the term “cloud computing network” refers to a network with a processing environment comprising configurable computing physical and logical resources, for example, networks, servers, storage, applications, services, etc., and data distributed over a network, for example, the internet. The cloud computing network provides on-demand network access to a shared pool of configurable computing physical and logical resources. The carbon emissions management application is programmed to collect the emission data wirelessly transmitted from the detectors 302 via the communication protocol.

FIG. 4 exemplarily illustrates the carbon emissions management application hosted on a cloud computing network 401. The carbon emissions management application assimilates real time emission data from the sensor as disclosed in the detailed description of FIG. 2. The carbon emissions management application collects the emission data from the detectors via a centralized server located on the entity's premise or on the cloud computing network 401 and provides real time values of carbon emissions to report accurate numbers. The emission data flows from data sources to an operational data store and a data warehouse via an extraction, transformation and loading (ETL) process for external reporting purposes and internal management analytics. This process allows business users to visualize the emission data at an earlier stage in the development cycle and helps the business user to further refine requirements as the data is readily available on the cloud grid. Some examples of programming languages that can be used for programming the carbon emissions management application comprise C, C++, Java®, hypertext preprocessor (PHP), .NET, etc. The carbon emissions management application is programmed in an integrated design environment using the Eclipse framework executing on 32 bit/64 bit operating systems platforms. The carbon emissions management application provides end user applications, for example, data analysis and reporting, data mining, dashboards, pie charts, what-if analysis, external reporting, supply chain management, suppliers category, emission footprints results categorized by country, region, factory, product and supplier, etc., accruement of carbon emissions, regulations and compliances.

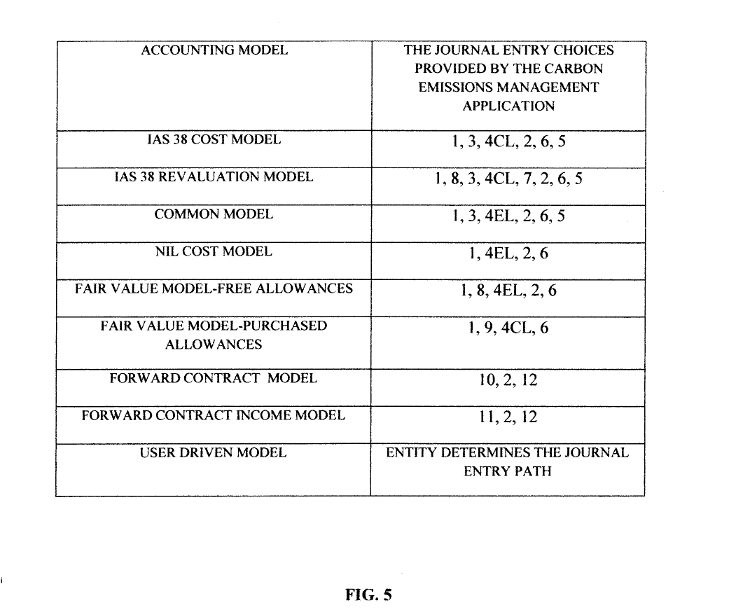

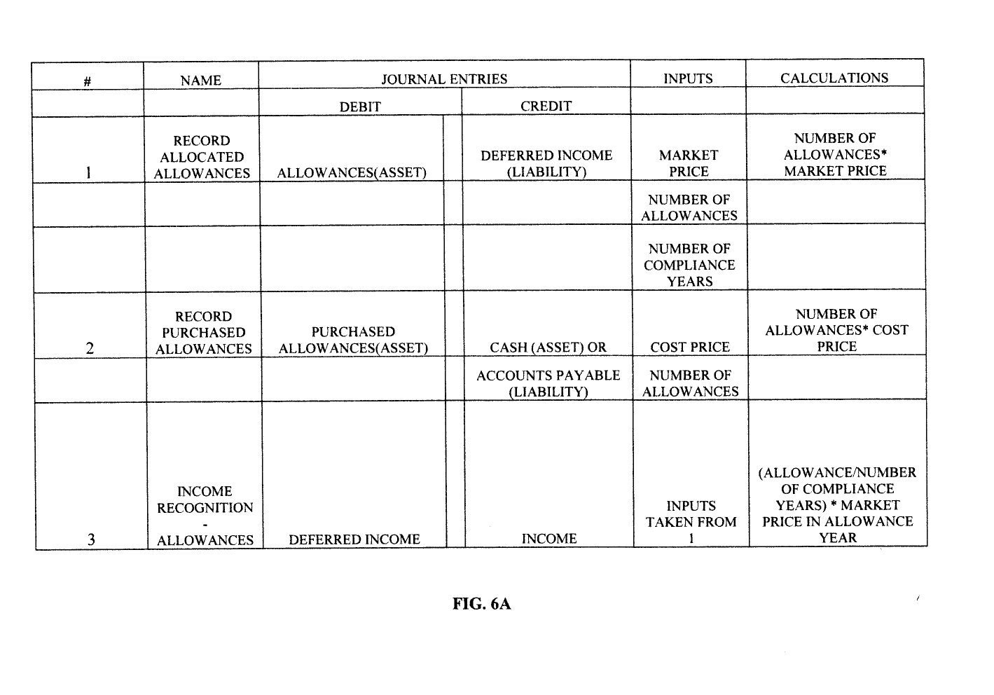

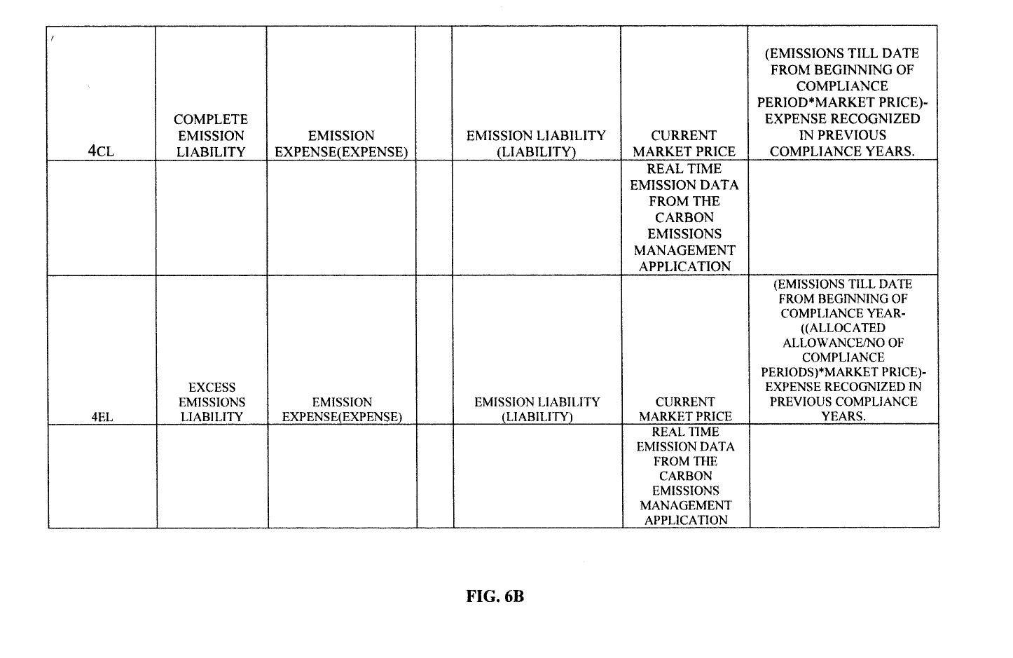

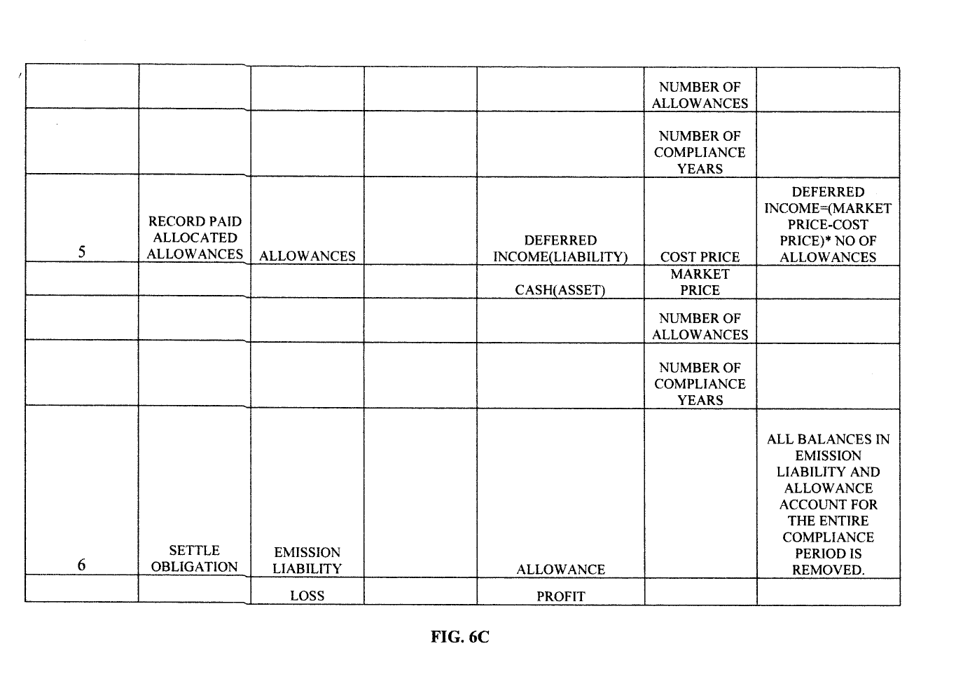

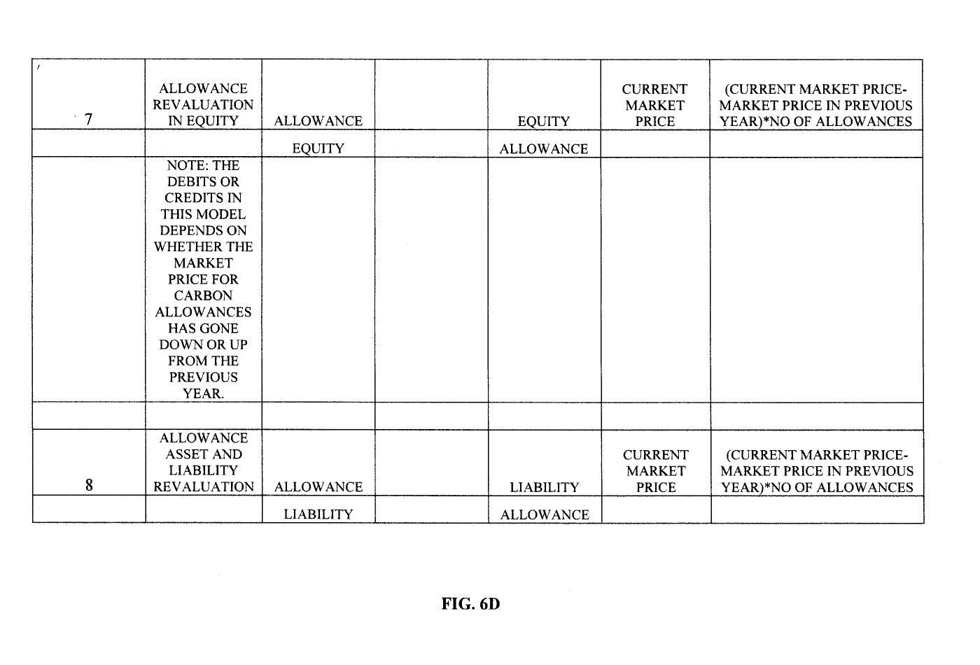

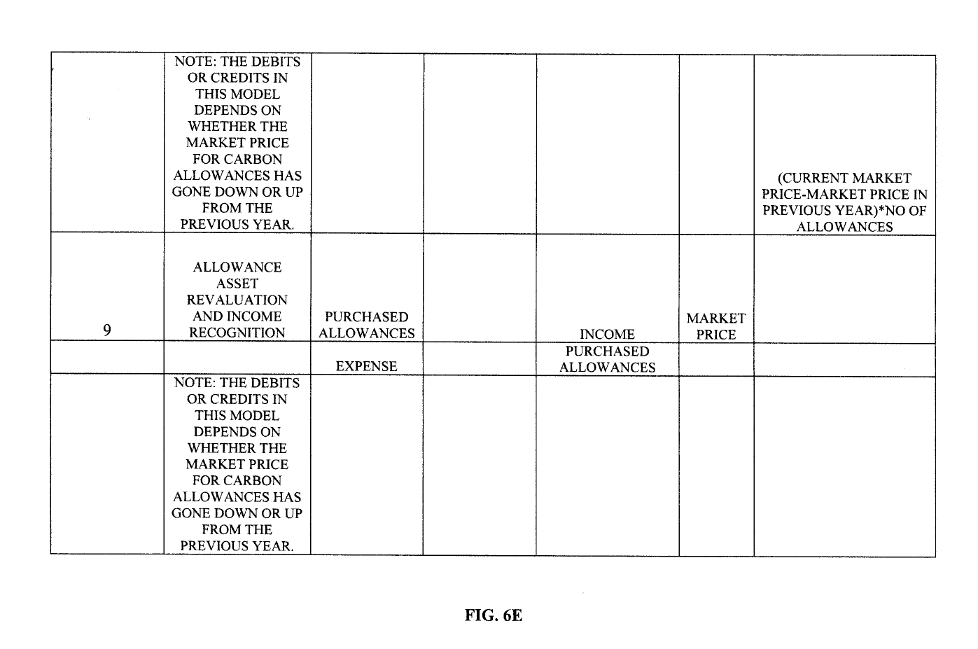

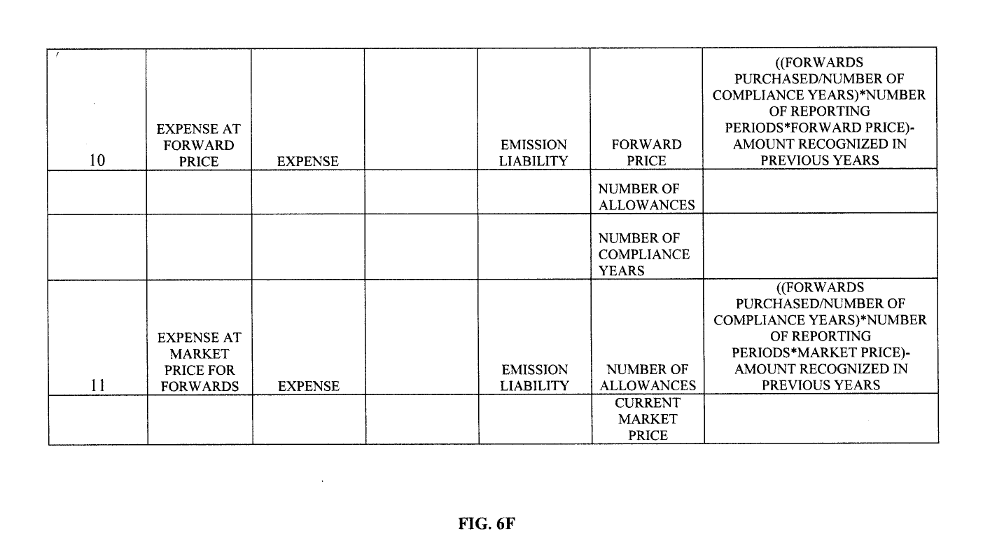

FIG. 5 exemplarily illustrates a table showing multiple accounting models and the journal entry choices provided by the carbon emissions management application for each of the accounting models. There are a number of different interpretations under the International financial reporting standards (IFRS) currently being followed by entities in the world in terms of treatment of carbon accounting for carbon emissions. The accounting models supported by the carbon emissions management application are, for example, an intangible assets (IAS) 38 cost model, an IAS 38 revaluation model, a common model, a nil cost model, a fair value model for free allowances, a fair value model for purchased allowances, a forward contract model, a forward contract income model, a user driven model, etc. The accounting models support multiple journal entry choices provided by the carbon emissions management application as disclosed in the detailed description of FIGS. 6A-6F. For example, the IAS 38 cost model supports journal entry choices 1, 3, 4CL, 2, 6, and 5; the IAS 38 revaluation model supports journal entry choices 1, 8, 3, 4CL, 7, 2, 6, and 5, etc. The accounting models follow various applications of the International financial reporting interpretations committee (IFRIC).

The carbon emissions management application allows users to choose the path that they would like to follow for carbon accounting within acceptable and conventional parameters of financial reporting. The user starts a compliance period when allowances are given. The carbon emissions management application assigns a unique identifier and a name for the compliance period. The unique identifier and the name allow the user to return back to the compliance period each time the user logs into a financial account. The carbon emissions management application enables the user to create accounts for the compliance period, make journal entries, and choose an accounting model to dictate the accounting path to be taken. The carbon emissions management application then allows the user to close the compliance period once obligations are settled. The carbon emissions management application stores the compliance period for record keeping and revisions in a database which is accessible at a later time. The carbon emissions management application enables the user to start more than one compliance period sessions in parallel, thereby providing the user the opportunity to assess which model is right for the entity. The carbon emissions management application also allows for any journal entry in a compliance period to be deleted. The journal entries can also be imported from the user driven model into other pre-programmed accounting models allowing for increased flexibility and adaptation to changing accounting rules.

The IAS 38 cost model defines guidelines provided by the International accounting standards board (IASB) for accounting treatment of intangible assets which are non-monetary assets that lack physical substance and are identifiable. The IAS38 cost model treats carbon allowances as intangible assets. The entity records the initial allocation at market price and continues to carry the asset at this initial allocation till the end of the compliance period. The IAS38 cost model also recognizes a government grant that will be credited to income as emissions are made. If there is an initial price paid that is less than the market price, the difference between the market price and the price paid is recognized as a grant through a credit to the deferred income liability account. This deferred income is credited to income as emissions are made. The entity recognizes the total liability for emissions made at a fair value or at a weighted average cost of all allowances given or purchased according to the user's choice at the end of every compliance year. The carbon emissions management application adopts a total liability method for recording the real time liability by collecting the emission data from the detectors via the wireless communication protocol, for example, the IEEE 802.15.4 Zigbee® wireless protocol. The entity recognizes the acquisition of emission allowances for any excess emissions that are required. The entity settles the liability for emissions made over the entire compliance period by closing out the liability and allowance accounts, delivers the allowances, and also recognizes a loss or a profit in the process. The IAS 38 cost model is the benchmark against which the other accounting models are compared. The following accounting models will be elaborated based on similarities or variations with the IAS 38 cost model.

The IAS 38 revaluation model is similar to the IAS 38 cost model for treatment of allowances as intangible assets. However, after the initial recognition, the allowance shall be carried at a revalued amount at a fair value at the date of the revaluation every compliance year. The IAS 38 revaluation model is similar to the IAS 38 cost model in all other aspects. The common model is a variation of the IAS 38 cost model with the only difference being that the entity recognizes the liability for only those emissions in excess of allocated allowances. That is, the carbon emissions management application adopts an excess liability method for recording the real time liability by capturing the emission data from the detectors. The nil cost models recognizes allowances and deferred income at zero when allowances are provided for free. Emission liability is recognized every compliance year in the excess liability method. There is no deferred income or income recognition in the nil cost models.

In the fair value model for free allowances, after the recording of initial free allowances as an asset along with a credit to liability for the allocation, at fair value in the year of receipt of allowances, the entity revalues the allowance and liability at fair value every year and carries the allowance and the liability at fair value. The entity then recognizes liability for emissions every year using the excess liability method until the final compliance year when obligations are settled and allowances, emission liability, and liability for allowances are erased from the records. In the fair value model for purchased allowances, the allowances are not free and need to be purchased. The purchased allowances are recorded at a cost with a credit to cash feature. The entity re-measures purchased allowances at fair value every compliance year and carries the purchased allowances at fair value. The entity then recognizes liability for emissions every year using the complete liability method. In the final compliance year, the entity settles the liability for emissions made over the compliance period, erases the emission liability and allowances from the records, and delivers the allowances.

The forward contract model is for entities entering into forward contracts applying the “own used exemption” to forwards. As used herein, the term “forwards” refers to an agreement or a contract associated with an asset that binds one or more parties to oblige to the agreement. The forwards are purchased, for example, when electricity is sold for the whole compliance period. An accounting entry with respect to the forward purchase is not made at this time. The liability of emissions to date is measured every compliance year at a fair value. In the final compliance year, the entity recognizes the acquisition of emission allowances at a strike price and settles the liability for emissions made over the compliance period. In the forward contract-income model, an accounting entry is not made at the time of purchase of forwards. The liability of emissions to date is measured every compliance year at a fair value. In addition, income or expense is recognized for differences in forward price of allowances purchased and the current market price. The entries are made to asset account, for example, forwards and to the income or expense account depending on the direction of the market price change. In the final compliance year, the entity recognizes the acquisition of emission allowances at the strike price and settles the liability for emissions made over the compliance period. In the user driven model, the users can create their own journal entries. The journal entries can also be imported from the user driven model into other accounting models to create different combinations with other accounting models and increase flexibility and adaptation to changing accounting rules.

FIGS. 6A-6F exemplarily illustrates journal entry table for multiple journal entry choices provided by the carbon emissions management application. The journal entry choices provided by the carbon emissions management application are, for example, record allocated allowances, record purchased allowances, income recognition-allowances, complete emission liability, excess emissions liability, record paid allocated allowances, settle obligation, allowance revaluation in equity, allowance asset and liability revaluation, allowance asset revaluation and income recognition, expense at forward price, expense at market price for forwards corresponding to journal entries 1, 2, 3, 4CL, 4EL, 5, 6, 7, 8, 9, 10, and 11 respectively in the journal entry table as exemplarily illustrated in FIGS. 6A-6F. In the journal entry table, for journal entries 4CL and 4EL, if the user chooses the weighted average option instead of a market price option, the market price used for calculations of emission liability and emission expense can be replaced by a weighted average of all allowances, thus far in the compliance period.

FIG. 7 illustrates the real time gas level as a graph with % of Co2 in real time plotted on Y-Axis and time on X-Axis (Every 5 minutes and the output is inputted into the software developed by the inventors for which the provisional utility patent is filed.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

This section describes the utility software developed for this patent and screenshots for each section is attached to clearly describe the functionality and scope. The software is divided into 2 Sections:

(A) Analytics Section: This section is used to analyze as well as measure various Scope1, Scope2, Scope3 emission.

(B) Accounting Section: Tracks the Co2 emissions during an entire accounting period using various pre-defined accounting models.
(A) Analytics Section:

This section has various sections to help a given user to measure and analyze CO2 emission throughout defined accounting period.
1) Get Started:
   a) Corporate: Helps define data related to corporate information. (Address, GHG champion, GHG Accountant etc)
   b) Business Unit: Helps in defining information about sub-business units of a given organization.
   c) Emission Sources: Helps defining/initializing various GHG sources which will be computed during defined accounting period.

Emission Sources Screen:

Description: This is one of the important screens which help a firm (Sub business units) to define all emission sources for
Scope1—Direct Emissions,
Scope2—Indirect Emissions,
Scope3—Indirect Emissions

Scope1 emission sources are further divided into 2 sub categories:
(a) Stationary
(b) Mobile
Scope1 (Stationary) Emission Sources:

These emission sources are directly read from physical sensor (Co2 Meter Sensor used to develop this software with provision to seamlessly plug in to Zigbee network). These various attached physical sensors send data over network which will captured by the software (Developed for validating this patent) and further processed and analyzed.

Scope 1 (Mobile) Sources: This section of the developed software will generally have all fuels defined and the values have to be manually entered.
Scope2—Indirect Emissions:

These emissions sources basically consist of electricity & steam utilized in a given business unit and values are entered manually.
Scope3—Indirect Emissions:

These sources will consist of vans, cars, flights, waste supply, garbage etc. These values will be manually entered.

Measure:

This is another important screen developed from the software where-in all actual values regarding emission sources (defined in emission sources section) are recorded.

This tabular format gives actual emission values & equivalent CO2 emission.

The values which are entered are multiplied with GWP factor which is defined by the respective Government organization and the number varies from country to country which has been defined in the developed software based on latest reports.

Scope 1 values read via physical sensors directly

Scope2 & scope3 values are manually entered.

Report:
This section will help understand various emission factors in fancy bar graphs.
   (a) Your organization's greenhouse gas emission by year.
   (b) Your organization's (according to sub business units) emissions compared to your reduction target.
   (c) Your organization's emissions tabulated by source and business unit, per year.

Reduce:
Reduction checklist list which can act as guideline list to reduce overall carbon footprint for organization.

Offset.
This screen can help an organization BUY carbon offsets for their company from market.

(B) Accounting Section

This section will read all recorded values from analytics section and use it for accounting purposes.

There are multiple predefined accounting models of which a given user can choose for a given accounting period.

Work Flow:

Step 1: (One Time)

Go to Setup screen and initialize all setting at start of accounting period.

Input parameters:

Accounting period, Market price and few other input parameters depending upon chosen accounting model.

Step 2:

This section will help you setup all company related information.

Step 3: (One Time)

Create various new accounts required during accounting period

Step 4. (At Regular Interval)

Make appropriate Journal entries at regular intervals in the accounting software that was developed for validating this patent.

Step 5: Following reports can be obtained from this screen
Banking & ledger tab>General Ledger reports
Chart of Accounts
List of Journal Entries
GL Account Transactions
Annual Expense Breakdown
Balance Sheet
Profit and Loss Statement

Trial Balance

Tax Report

Audit Trail

Annual Balance Breakdown—Detailed

Annual Expense Breakdown—Detailed

The computer implemented method (Software) and system disclosed herein address the above stated needs for a tracking, monitoring, and reporting system that provides real time information in order to enable business managers and other entities to meet government legislation and compliance requirements, operate in a more environmentally sustainable manner, and report accurately economic conditions and carbon performance of the entities using the real time information via a communication protocol, for example, a Zigbee® wireless protocol of Zigbee Alliance Corporation. The computer implemented method and system disclosed herein also addresses the above stated need for assimilating scope 1 emissions along with scope 2 emissions. The carbon emissions management application performs real time analytics and scope 1 carbon emissions reporting by aggregating real time scope 1 emissions data from detectors, for example, infra-red sensors instantaneously, for example, using the 802.15.4 Zigbee wireless protocol.

This software was designed using Co2meter.com's K30 sensor (CM-0039: USB CO2 Probe Data Logger 1-30-100 o/o—USB Probe K30 1% and purchase price of $209) to capture data from the sensor in real-time while it is attached to the computer through a USB port connected to the desktop. This will download all logs currently stored on the device and allow the user to save and delete them from the device. Log downloading may take up to 10 minutes depending on the device and transfer speed. The same concept can be applied using a wireless Zigbee sensor on a massive scale.

The carbon emissions management application receives inputs, for example, from the infrared sensors (CO2 sensor used for validating this patent) OR through the 802.15.4 Zigbee wireless protocol. The computer implemented method and system disclosed herein also addresses the above stated need for reporting automatic real time carbon emission updates of scope 1 greenhouse gas (GHG) emissions, while providing an accounting system for the purpose of updated real time external financial reporting. The computer implemented method and system implements an interaction between detectors, for example, Real time Co2 sensors and a computer application, herein referred to as the “carbon emissions management application” that is programmed to receive inputs from the infrared Co2 real time sensors for financial tracking and reporting for commercial enterprises.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A real time carbon emissions assimilation, reporting and management system utility software comprising of analytics and accounting data for a computer implemented method and system, that provides a carbon emissions management application (CEMA) for assimilating real time emission data (RTED) from sensors via a communication protocol (infrared sensors connected directly to the computer via USB or through Zigbee communications protocol), analyzing, and reporting of the RTED compliant with a governing body. The CEMA performs analytics using the RTED obtained from the detectors, that is, scope 1 emissions, user information, that is, scope 2 emissions resulting from purchased electricity, heat, etc., and supply chain data, that is, scope 3 emissions resulting from extraction and production of purchased materials from suppliers. The CEMA manages a carbon accounting system for reporting of the RTED by creating and managing financial statements, records such as journal entries associated with the RTED, etc., and setting up a compliance period for an entity during which the entity must disclose adequate allowances to meet carbon emissions by providing multiple accounting models and journal entry choices for calculation of the carbon emissions
